(19) United States
(12) Patent Application Publication
(10) Pub. No.: US 2022/0320918 A1
(43) Pub. Date: Oct. 6, 2022

(54) THREE-PHASE ASYNCHRONOUS ELECTRIC MACHINE AND METHOD OF MANUFACTURE THEREOF

(71) Applicant: U.T.T. Unique Transformer Technologies Ltd., Or Akiva (IL)

(72) Inventors: Yuri BOLOTINSKY, Netanya (IL); Eliezer ADAR, Herev La Et (IL)

(21) Appl. No.: 17/642,209

(22) PCT Filed: Aug. 30, 2020
(86) PCT No.: PCT/IL2020/050938

§ 371 Date: Mar. 10, 2022

(30) Foreign Application Priority Data
Sep. 10, 2019 (IL) 269253

(51) Int. Cl. H02K 1/14; H02K 17/12; H02K 15/02

(52) U.S. Cl. CPC H02K 1/148; H02K 17/12; H02K 15/022

(57) ABSTRACT

Disclosed are axial-gap electrical machines which magnetic core elements are made of wound magnetic ribbons to provide relatively lightweight and small size implementations that can be operated in a wide range of operational modes with minimized magnetic and electrical losses. The axial-gap electrical machine includes a cylindrically-shaped stator assembly having a central passage passing therealong, a rotatable shaft passing within the central passage of the stator assembly coaxial to the axis of rotations of the electric machine, and one or two annular rotor assemblies concentrically attached to the shaft and magnetically coupled to the at least one cylindrically-shaped stator assembly. The stator assembly can have a plurality of prism-shaped magnetic core elements made from a plurality of magnetic ribbon layers extending along its length, and a primary winding comprising a plurality of coils mounted over the prism-shaped magnetic core elements.

### CROSS REFERENCE TO RELATED APPLICATION(S)

This application is a national phase filing under 35 C.F.R. § 371 of and claims priority to PCT Patent Application No. PCT/IL2020/050938, filed on Aug. 30, 2020, which claims the priority benefit under 35 U.S.C. § 119 of Israeli Application No. 269253 filed on Sep. 10, 2019, the contents of each of which are hereby incorporated by reference in their entireties.

### BACKGROUND

Some embodiments of the presently disclosed subject matter is generally in the field of axial-gap motors, and particularly asynchronous three-phase axial-gap electric machines.

Three-phase axial-gap asynchronous motors including disk-shaped stator(s) and/or rotor(s) are known. Usually, such axial-gap three-phase asynchronous motors are used in a variety of low-power devices, typically operated by a three-phase electric current supply having a constant frequency. These motors typically have a central shaft linked to the rotor(s) configured to rotate about an axis of rotations (i.e., the axis of the motor), and their rotor(s) is separated from the stator of the motor by a vertical air gap, so the magnetic flux in this motor arrangement flows axially across the air-gap.

Recently, magnetic ribbons (e.g., made of amorphous soft magnetic material) are used in fabrication of magnetic systems of such three-phase asynchronous motors due to their beneficial magnetic properties (low loss, high magnetic permeability) and mechanical properties (high strength and rust resistance). The use of magnetic ribbons made of amorphous materials in motor cores is particularly advantageous due the high efficiency and low cost, resulting in a substantial reduction of losses in the magnetic system, and accordingly in increase of coefficient of efficiency of the motors. These improvements in the motors' performance is advantageous for heavy-duty engines (e.g., 50-200 kW) operated by alternating frequency electrical currents, such as used in electrical vehicles.

U.S. Pat. No. 6,784,588 describes a high efficiency electric motor having a generally polyhedrally shaped bulk amorphous metal magnetic component in which a plurality of layers of amorphous metal strips are laminated together adhesively to form a generally three-dimensional part having the shape of a polyhedron. The bulk amorphous metal magnetic component may include an arcuate surface, and can preferably includes two arcuate surfaces that are disposed opposite to each other. The magnetic component is operable at frequencies ranging from about 50 Hz to about 20,000 Hz. When the motor is operated at an excitation frequency “f” to a peak induction level Bₘₐₓ, the component exhibits a core-loss less than about “L” wherein L is given by the formula L=0.005·f(Bₘₐₓ)^{1.5}+0.000012·f^{1.5}(Bₘₐₓ)^{1.6}, the core loss, the excitation frequency and the peak induction level being measured in watts per kilogram, hertz, and teslas, respectively.

U.S. Pat. Nos. 7,144,468 and 6,803,694 suggests forming unitary amorphous metal magnetic components for an axial flux electric machine, such as a motor or generator, from a spirally wound annular cylinder of ferromagnetic amorphous metal strips. The cylinder is adhesively bonded and provided with a plurality of slots formed in one of the annular faces of the cylinder and extending from the inner diameter to the outer diameter of the cylinder. These components are employed in constructing a high efficiency, axial flux electric motor. When operated at an excitation frequency “f” to a peak induction level Bₘₐₓ the unitary amorphous metal magnetic component has a core-loss less than “L” wherein L is given by the formula L=0.0074·f(Bₘₐₓ)^{1.3}+0.000282·f^{1.5}(Bₘₐₓ)^{2.4}, the core loss, excitation frequency and peak induction level being measured in watts per kilogram, hertz, and teslas, respectively.

U.S. Pat. No. 8,836,192 discloses an axial gap rotating electrical machine and rotor used therefor. In the axial gap rotating electrical machine, the rotor includes a rotor yoke that is formed by wrapping amorphous ribbon wound toroidal core, which is obtained by winding an amorphous magnetic metal ribbon into a toroidal core. Magnets having plural poles are circumferentially disposed on a stator-facing surface of the amorphous ribbon wound toroidal core.

U.S. Pat. No. 8,680,736 describes an armature core including a core portion formed of a lamination of plural non-crystalline metallic foil bands, wherein the armature core is provided with at least two cut surfaces with respect to the lamination layers. Amorphous metal is used as the iron base of the non-crystalline metallic foil bands. The cut surfaces are perpendicular to the lamination layers of the non-crystalline foil bands. Still further, the stator includes a stator core holding member in a disc form, the stator having a plurality of holes or recessions that are substantially in the same shape as a cross-sectional shape of the stator cores and wherein the stator cores are inserted in the holes or recessions of the stator core holding member and held by fixing in vicinities of respective central portions thereof, the central portions being with respect to the axial direction thereof.

Canadian patent No. 1139814 describes an induction motor of the squirrel cage type having a stator body and a rotor body which are each made of a coil of concentric layers of a thin amorphous metal tape. The tape is slotted to receive the rotor and stator windings. The motor is similar to a conventional disk type motor except that the secondary, instead of being a solid copper or aluminum disk, is a coil of concentric turns of notched amorphous metal tape which improves the efficiency by reducing the effective air gap. A method of manufacture of the coil of tape is disclosed wherein identical notches are formed in the tape edge with a progressively increasing spacing between the notches, which after winding of the tape, permits the notches to come into radial register with one another to form slots in the end of the stator or rotor body.

### SUMMARY

Some embodiments of the presently disclosed subject matter generally concerns axial-gap (also known as axial flux) electrical machines which magnetic core elements are made of wound magnetic ribbons, made of soft magnetic materials, such as but not limited to, amorphous or nano-crystalline ribbons, configured to substantially minimize magnetic losses in the cores. Axial-gap electric machines are typically bulky and heavy units operated at limited operational ranges due to magnetic losses of their magnetic core elements. The axial-gap electrical machine embodiments disclosed herein provide relatively lightweight and small size implementations that can be operated in a wide range of operational modes with minimized magnetic and electrical losses.

The axial-gap electrical machine embodiments disclosed herein include at least one cylindrically-shaped stator assembly having a central passage/channel passing therealong, a rotatable shaft passing within the central passage of the stator assembly coaxial to the axis of rotations of the electric machine, and at least one annular rotor assembly concentrically attached to the shaft and magnetically coupled to the at least one cylindrically-shaped stator assembly. In some embodiments the central passage of the stator assembly is substantially cylindrically-shaped.

The stator assembly includes a plurality of prism-shaped magnetic core elements, each constructed from a plurality of longitudinally extending magnetic ribbon layers mounted in the stator assembly such that the long axes of the magnetic ribbon layers are substantially parallel to the axis of rotations of the stator. As will explained in details hereinbelow, gaps between adjacently located magnetic ribbon layers in the prism-shaped magnetic core elements can be filled with non-magnetic materials. The prism-shaped magnetic core elements are arranged in the stator such that their apex angles are directed towards the axis of rotation of the electric machine, and their planes of symmetry radially extends from the axis of rotation. At least one coil is placed over each prism-shaped magnetic core element of the stator to provide magnetic poles of the stator at their ends in operational states of the electric machine.

The prism-shaped magnetic core elements of the stator are evenly and circumferentially distributed inside the stator assembly about the shaft/axis of rotation of the electric machine. This way, the magnetic ribbon layers of the prism-shaped magnetic core elements of the stator can be substantially tangentially aligned with respect to the annular arrangement of the core elements. In some embodiments the prism-shaped magnetic core elements of the stator are attached between two electrically non-conducting and non-magnetic parallel disk-shaped support elements. However, other attachments can be used in addition to, or instead of, the disk-shaped support elements e.g., using electrically non-conducting and non-magnetic arc-shaped attachment ribs and/or curved attachment plates for connecting between each pair of adjacently located prism-shaped core elements of stator.

The rotor assembly includes a toroidal-shaped magnetic core element made of a spiral wound of magnetic ribbon and having a plurality of axial grooves passing between inner and outer rings of its spiral wound ribbon, and an electrically conducing spider structure including a plurality of radial spokes at least partially accommodated inside the radial grooves of the toroidal-shaped magnetic core element of the rotor. The rotor assemblies are mounted on the rotatable shafts such that their magnetic core elements, and the electrically conducting spider structures thereby held, are facing the annular end side of the stator i.e., facing the magnetic poles of the stator, or between two stators of the electric machine has more than one stator assembly.

The electrically conducting spider structure of the rotor includes in some embodiments inner and outer electrically conducting rings, and its spokes are implemented by a plurality of electrically conducting plates electrically connected to (e.g., by soldering), and radially extending between, the inner and outer rings, such that the plates reside in radial planes defined by the concentric rings. In some embodiments at least some portion of each electrically conducting plate is received in a respective radial groove formed in the toroidal-shaped magnetic core element of the rotor assembly. Accordingly, some portion of each electrically conducing plate of the spider structure can protrude outwardly from its respective radial groove, thereby forming a plurality of fan blades configured to stream air towards, and ventilate, the stator assembly and its central passage. The geometrical dimensions of the electrically conducing plates can be adjusted to guarantee that a defined efficiency level is maintained for all or most operational electrical supply frequencies in which the electrical machine is designed to operate, to thereby set a desired efficiency factor of the machine.

In some embodiments the rotor assembly includes an electrically non-conducting and non-magnetic disk-shaped base element configured to hold the toroidal-shaped core element of the rotor with the electrically conducting spider structure thereby held. The disk-shaped base element of the rotor can have concentric inner and outer annular lips axially protruding from a surface area thereof to form an annular cavity in which the toroidal-shaped core element of the rotor is received and held (e.g., by adhesion and/or screws). In some embodiments the disk-shaped base element of the rotor includes a plurality of ventilation channels radially passing in the same face having the annular cavity. The radial channels pass between and through the inner and outer lips, and also through the annular cavity, to thereby form ventilation channels configured to facilitate passage of air between the outer volume/environment of the electric machine and the central passage of the stator assembly.

The term electric motor (or motor for short), as used herein, generally refers to rotating electrical machines which additionally include electric generators as well as regenerative motors that may be operated optionally as electric generators. The motor embodiments disclosed herein may be employed in constructing any of these devices. In the asynchronous electrical motors embodiments disclosed herein, the magnetic field of the motors is generated by an alternating current (AC) supplied to the stator assembly by an AC power source, and the angular velocity of the rotors, n, depends on the frequency f of the electrical supply of the motors.

The term electrically non-conducting material, as used herein, refers of materials having very low electrical conductivity, such as dielectric and/or electrically insulating materials, which are well known to those skilled in the art of the present application. The term non-magnetic material, as used herein, refers to materials that cannot be magnetized, such as but not limited to Aluminum, Copper, plastics.

Some embodiments of the presently disclosed subject matter thus teaches techniques and construction of three-phase asynchronous electric machines designed to operate on a variable frequency electrical current supply e.g., in the range of 25 to 525 Hz. Depending on the selected operating frequency, different modes of operation are obtained characterized by respective torque and angular velocity (rotations speed). In such embodiments, starting charactering features of the electric machine can be calculated for a frequency of 250 Hz, the maximal speed of rotations is obtained at a frequency of 525 Hz, and the minimal speed at a frequency of 25 Hz.

One inventive aspect disclosed herein relates to a stator assembly for an axial-gap electric machine. The stator assembly including a plurality of magnetic core made in the form of a prism, each of the prism-shaped magnetic core elements including a plurality of (parallel) magnetic ribbon layers extending along its length, a plurality of coils constituting a primary winding of the axial-gap electric machine, each of the coils mounted over one of the prism-shaped magnetic core elements, and a support structure configured to fixedly hold the prism-shaped magnetic core elements circumferentially arranged therewithin about and parallel to an axis or rotation of the electric machine, such that an apex angle of the prism-shaped magnetic core elements is directed towards the axis of rotation of the electric machine, and planes of symmetry of the prism-shaped magnetic core elements radially extends from the axis of rotation.

Optionally, but in some embodiments preferably, cross-sectional shape of the prism-shaped magnetic core element is substantially of an isosceles triangle having an acute apex angle. The support structure includes in some embodiments two electrically non-conducting and non-magnetic disk-shaped support elements. The prism-shaped magnetic core elements are attached in the stator assembly between the disk-shaped support elements substantially perpendicularly thereto. The magnetic ribbon layers can be made from a type of amorphous, or nano-crystalline, magnetic material.

The stator assembly includes in some embodiments electrical conductors interconnecting between the coils to form a three-phase coil system and configured to provide a determined number of magnetic poles of the stator assembly once electrically connected to a three-phase electric power supply.

In some embodiments the stator assembly includes eighteen prism-shaped magnetic core elements circumferentially arranged therein. With this arrangement the interconnection between the coils by the electrical conductors can be configured to form six magnetic poles.

Another inventive aspect disclosed herein relates to a rotor assembly for an axial-gap electrical machine. For example, and without being limiting, the axial-gap electrical machine can include a stator assembly according to any of the embodiments disclosed hereinabove or hereinbelow. The rotor assembly includes a toroidal-shaped magnetic core element formed from a spiral wound of magnetic ribbon, where the toroidal-shaped magnetic core element includes a plurality of radial grooves extending between inner and outer rings/loops of its spiral wound ribbon, and a spider-shaped electrically conducting structure constituting a secondary winding of the axial-gap electrical machine. The electrically conducting spider structure including a plurality of electrically conducting spokes radially extending between concentric inner and outer electrically conducing rings electrically connected to the spokes. Each of the electrically conducting spokes can be configured to be received at least partially in a respective one of the radial grooves of the toroidal-shaped magnetic core element.

Each of the electrically conducting spokes of the electrically conducting spider structure can be implemented by an electrically conducting plate radially extending between the concentric inner and outer electrically conducing rings. Optionally, but in some embodiments preferably, a portion of each of the electrically conducting plates protrude outwardly from the respective radial groove of the toroidal-shaped magnetic core in which it is placed. This way, the rotor assembly is adapted to stream air towards the stator assembly during operation of the axial-gap electrical machine. Geometrical dimensions of the electrically conducting plates can be selected to set a defined efficiency factor of the axial-gap electrical machine.

The rotor assembly includes in some embodiments a disk-shaped base element made of a nonmagnetic and electrically non-conducting material. The disk-shaped base element can be configured to receive and hold the toroidal-shaped magnetic core element of the rotor assembly. The disk-shaped base element can have concentric inner and outer annular lips axially protruding from its surface. The inner and outer annular lips can be configured to form an annular cavity configured to receive and hold the toroidal-shaped magnetic core element of the rotor assembly. Optionally, but in some embodiments preferably, the disk-shaped base element includes a plurality of radial grooves passing between and through the concentric inner and outer annular lips. The radial grooves can be configured to facilitate passage of air therethrough for ventilating the stator assembly during operation of the axial-gap electric machine.

Yet another inventive aspect disclosed herein relates to an axial-gap electric machine including: at least one stator assembly having a plurality of magnetic core elements, each one of the magnetic core elements (also referred to herein as a prism-shaped magnetic core element) is made in the form of a prism constructed from magnetic ribbon layers extending along its length, and a primary winding including a plurality of coils mounted over the prism-shaped magnetic core elements; a rotatable shaft passing along a central passage/channel of the stator assembly; and at least one rotor assembly coupled or connected to the rotatable shaft and including a magnetic core element (also referred to herein as toroidal-shaped magnetic core element) made in form of toroid from a spiral wound of magnetic tape or ribbon, and a secondary winding (a short-circuited rotor winding/spider) having two concentric rings made of electrically conductive material (e.g., metal, such as Copper) and electrically conducting rods or plates (also referred to herein as spokes—e.g., made from an electrically conducting metal, such as Copper) radially extending between the two concentric rings and electrically connected to them. The electrically conducting rods or plates can be at least partially accommodated inside radial grooves of the toroidal-shaped magnetic core element.

Optionally, but in some embodiments preferably, the electrically conducting rods or plates are placed inside radial grooves formed in an end surface of the toroid-shaped magnetic (circuit) core element of the rotor assembly. In some embodiments the radially extending rods or plates of the secondary winding are configured to axially project from the surface of the toroid-shaped magnetic core element of the rotor assembly, and thereby form fan blades designed to direct the flow of cooling air to the stator windings and magnetic circuits during operation of the electric machine.

In general, the axial-gap electric machine can include at least one stator assembly according to any of the embodiments disclosed hereinabove or hereinbelow, a rotatable shaft located in a central passage passing along the stator assembly, and at least one rotor assembly according to any one of the embodiments disclosed hereinabove or hereinbelow concentrically mounted on the rotatable shaft such that an axial-gap is formed between the spider-shaped electrically conducting structure of the rotor and the at least one stator assembly.

Yet another inventive aspect disclosed herein relates to a method of constructing a stator assembly for an axial-gap electric machine. The method including preparing one or more rectangular-shaped toroid structures from wound magnetic ribbon media, cutting from the rectangular-shaped toroid structure one or more rectangular parallelepiped pieces, cutting from each of the rectangular parallelepiped pieces one or more prism-shaped magnetic core elements, placing over each of the prism-shaped magnetic core elements one or more coils constituting a primary winding of the axial-gap electric machine, and circumferentially mounting the prism-shaped magnetic core elements within a support structure about and parallel to an axis or rotation of the electric machine, such that an apex angle of the prism-shaped magnetic core elements is directed towards the axis of rotation, and planes of symmetry of the prism-shaped magnetic core elements radially extends from the axis of rotation.

The mounting of the prism-shaped magnetic core elements within the support structure can include attaching the prism-shaped magnetic core elements between two electrically non-conducting and non-magnetic disk-shaped support elements. The method can include interconnecting between the coils to form a three-phase coil system configured to provide a determined number of magnetic poles to the stator assembly. In some applications the stator assembly includes eighteen prism-shaped magnetic core elements. This way the interconnecting between the coils can be configured to form six magnetic poles.

Yet another inventive aspect disclosed herein relates to a method of constructing a rotor assembly. For example, and without being limiting, the rotor assembly can be used in the axial-gap electrical machine including the stator assembly of any of the embodiments disclosed hereinabove and hereinbelow. The method including preparing a toroidal-shaped magnetic core element from a spiral wound of magnetic ribbon media, forming in the toroidal-shaped magnetic core element a plurality of radial grooves extending between inner and outer rings of its spiral wound ribbon media, preparing a spider-shaped electrically conducting structure by electrically connecting a plurality of electrically conducting spokes between concentric inner and outer electrically conducing rings together constituting a secondary winding of the axial-gap electrical machine, attaching the spider-shaped electrically conducting structure to the toroidal-shaped magnetic core element such that each of the electrically conducting spokes of the spider-shaped electrically conducting structure is received at least partially in a respective one of the radial grooves of the toroidal-shaped magnetic core element.

The preparing of the spider-shaped electrically conducting structure includes in some embodiments using electrically conducting plates to implement the spokes. Optionally, and in some embodiments preferably, the preparing of the spider-shaped electrically conducting structure includes placing the electrically conducting plates in respective radial grooves of the toroidal-shaped magnetic core such that a portion of each of the electrically conducting plates protrude outwardly from the respective radial groove. The method includes in some embodiments determining geometrical dimensions of the electrically conducting plates to set a defined efficiency factor of the axial-gap electrical machine.

Optionally, but in some embodiments preferably, the method can includes preparing a disk-shaped base element made of a nonmagnetic and electrically non-conducting material, and attaching the toroidal-shaped magnetic core element of the rotor assembly to the disk-shaped base element. The method includes in some embodiments forming an annular cavity in the disk-shaped base element and placing the toroidal-shaped magnetic core element of the rotor in the annular cavity. The method including in some embodiments forming a plurality of radial grooves in the disk-shaped base element before placing the toroidal-shaped magnetic core element in the annular cavity. The radial grooves can facilitate passage of air and ventilation of the stator assembly during operation of the axial-gap electric machine.

Yet another inventive aspect disclosed herein related to a method of constructing an axial-gap electric machine (e.g., electric motor or dynamo). The method including preparing at least one stator assembly according to any one of the embodiments disclosed hereinabove or herein below, placing a rotatable shaft in a central passage passing inside the stator assembly, preparing at least one rotor assembly according to any one of the embodiments disclosed hereinabove or hereinbelow, and mounting the at least one rotor assembly on the rotatable shaft such that an axial-gap is formed between the spider-shaped electrically conducting structure of the rotor and the at least one stator assembly.

### BRIEF DESCRIPTION OF THE DRAWINGS

In order to understand some embodiments of the presently disclosed subject matter and to see how it may be carried out in practice, embodiments will now be described, by way of non-limiting example only, with reference to the accompanying drawings. Features shown in the drawings are meant to be illustrative of only some embodiments of the presently disclosed subject matter, unless otherwise implicitly indicated. In the drawings like reference numerals are used to indicate corresponding parts, and in which:

FIG. 1 is a schematic illustration of a perspective view of an axial-gap electric machine according to some possible embodiments;

FIGS. 2A and 2B schematically illustrate a stator of the axial-gap electric machine according to some possible embodiments, wherein FIG. 2A shows a perspective view of the stator and FIG. 2B shows a cross-sectional view of the stator;

FIGS. 3A to 3C schematically illustrate construction of a magnetic core element of the stator according to some possible embodiments, wherein FIGS. 3A and 3B exemplify a possible fabrication process of the stator magnetic core elements, and FIG. 3C shows a perspective view of a stator magnetic core with a coil;

FIGS. 4A and 4B schematically illustrate a stator assembly according to some possible embodiments, wherein FIG. 4A shows sectional views of the stator assembly, and FIG. 4B shows a perspective view of the stator assembly;

FIGS. 5A to 5G schematically illustrate rotor assemblies according to some possible embodiments, wherein FIG. 5A shoes two rotor assemblies mounted to a common rotatable shaft; FIG. 5B shows front and sectional views of a toroidal magnetic core of the rotor, FIG. 5C shows front and sectional views of a spider structure of the rotor, FIG. 5D shows front and sectional views of a disk-shaped base element of the rotor, FIG. 5E shows front and sectional views of the rotor assembly, FIG. 5F shows a sectional view of the rotatable shaft with two rotor assemblies mounted thereon, and FIG. 5G shows a perspective view of a rotatable shaft with two rotor assemblies mounted thereon;

FIGS. 6A and 6B respectively show perspective and sectional views of an axial-gap electrical machine according to some possible embodiments; and

FIG. 7 schematically illustrates electrical connection of the coils of the stator to a three-phase power source according to some possible embodiments.

### DETAILED DESCRIPTION OF EMBODIMENTS

One or more specific embodiments of the present disclosure will be described below with reference to the drawings, which are to be considered in all or most aspects as illustrative only and not restrictive in any manner. In an effort to provide a concise description of these embodiments, not all features of an actual implementation are described in the specification. Elements illustrated in the drawings are not necessarily to scale, emphasis instead being placed upon clearly illustrating the principles of some embodiments of the presently disclosed subject matter. Some embodiments of the presently disclosed subject matter may be provided in other specific forms and embodiments without departing from the essential characteristics described herein.

Some embodiments of the presently disclosed subject matter illustrated in the drawings and described below are generally intended for induction axial-gap electrical machines. These electrical machines can generally include one or more stator assemblies, each stator assembly having a generally open cylindrical shape structure with a central (cylindrical) channel passing therealong, and one or more disk-shaped rotor assemblies facing annular end sides of the stator assembly and spaced apart therefrom to form an axial air gap between each disk-shaped rotor assembly and a respective annular end side of the stator assembly.

The stator assembly, and/or the rotor assembly, including a magnetic core made of magnetic ribbons (e.g., made of amorphous metal). The magnetic ribbons of the magnetic core elements are wound or stacked to form multilayer structures arranged inside the rotor and stator of the electric machine such that the magnetic flux lines that passes through the magnetic core elements are substantially parallel to the magnetic ribbon layers, to thereby substantially prevent Eddy currents losses. Optionally, and in some embodiments preferably, gaps between adjacently located magnetic ribbon layer/tape of the magnetic core elements are filled with non-magnetic materials.

The rotor assemblies are fixedly attached to a central shaft configured to rotate about an axis of rotations passing through the central passage of the stator assembly. The air-gaps are located in axially spaced apart parallel planes, which are substantially perpendicular to the central shaft (i.e., perpendicular to the axis of the electrical machine), and substantially parallel to the annular end sides of the stator assembly.

The stator assembly includes in some embodiments a rigid frame including two disk-shaped support elements made of an electrically insulating non-magnetic material (e.g., made of a type of plastic or fiberglass material, such as STEF), and a plurality of magnetic core elements circumferentially distributed, and fixedly mounted, between the two disk-shaped support elements. In some embodiments the magnetic core elements are manufactured from magnetic ribbons made of soft magnetic material, such as but not limited to, an amorphous or a nanocrystalline material (e.g., iron-based materials such as, but not limited to, 2605SA1, 1K101, or nanocrystalline alloys such as, but not limited to, GM414). The magnetic core elements of the stator assembly can be formed with various different cross-sectional shapes (e.g., circular triangular, square, rectangular, polyhedral, or any other suitable polygonal shape).

In some embodiments the magnetic core elements of the stator assembly are elongated prism-shaped elements having a triangular cross-sectional shape. The elongated prism-shaped stator core elements are arranged in the stator assembly such that an apex angle of each prism-shaped stator core element is directed radially towards the axial shaft (i.e., the axis of rotations) of the stator. In possible embodiments the cross-section of the core elements of the stator is substantially of an isosceles triangle shape, and the apex angle of the core elements directed towards the axis of rotations of the rotor is an acute angle. The number of magnetic core elements used in each stator depends on the number of magnetic poles of the electric machine. Optionally, but in some embodiments preferably, 18 (eighteen) magnetic core elements are mounted in each stator assembly. As will be explained hereinbelow in details, this configuration of the magnetic core elements of the stator assembly is designed to maximize magnetic coupling between the magnetic core elements of the stator a secondary winding of the rotor over the axil gap of the electric machine.

Each stator magnetic core element is configured to receive at least one electromagnetic coil thereover of a primary winding of the electric machine. In some embodiments the electromagnetic coils of the primary winding are electrically interconnected to provide a three-phase coil system configured to receive/generate a three-phase electric power supply of the motor electric machine. For example, and without being limiting, the stator assembly can be arranged to provide 6 (six) magnetic poles with a primary winding having 18 (eighteen) magnetic core elements carrying electromagnetic coils electrically interconnected to form a three-phase electromagnetic coil system.

In order to minimize magnetic losses, in some possible embodiments the magnetic core elements of the stator are multilayered structures in which magnetic ribbon layers are arranged to form a prism-shaped stack of a plurality of parallel magnetic ribbon layers extending along the length of the magnetic core element. The magnetic core elements are mounted in the stator such that their parallel magnetic ribbon layers are (horizontal) parallel to the axis of rotation of the electric machine. This way, the direction of magnetic flux passing through each magnetic core of the stator coincides with the direction in which the amorphous ribbon layers extend within the magnetic core element i.e., along the length of the magnetic core, which thereby substantially minimizes the magnetic losses of the stator core.

The magnetic core elements of the stator can be attached (e.g., glued by strong adhesive materials, such as epoxy adhesive) to the electrically insulating disk-shaped support elements provided at the end faces of the stator assembly. The disk-shaped support elements can be further interconnected by spacers having arc-shaped cross-sections made of a rigid material (e.g., stainless steel), that are circumferentially attached over the outer diameter of the stator assembly. Optionally, but in some embodiments preferably, the electrically insulating disk-shaped support elements are interconnected by precise structural elements such as, but not limited to, stainless steel rods. This design provides accurate alignment between the circular end surfaces of the stator and annular faces of the disk-shaped rotor assemblies of the electric machine with a high accuracy e.g., about 0.01 mm.

Accordingly, the magnetic core system of the stator forms a central (cylindrical) channel passing along the axis of rotation of the electric machine. The central shaft of the electric machine is placed to extend along the central channel/passage of the stator assembly, such that the one or more disk-shaped rotor assemblies fixedly attached to it are substantially parallel to the annular end faces of the stator assembly, and spaced apart therefrom to provide an air gap therebetween of about 0.25 to 1.0 mm.

Each rotor assembly can have a disk-shaped base element made of a nonmagnetic and electrically insulating material (e.g., made of a type of plastic or fiberglass material, such as STEF-grade fiberglass) configured to hold a magnetic core of the rotor and a shorted secondary winding thereon. The disk-shaped base element is fixedly and concentrically attached to the shaft of the electric machine, and the magnetic core of the rotor assembly is fixedly and concentrically attached thereto such that it is facing a respective one of the annular end sides of the stator assembly i.e., to face the magnetic poles of the stator. Optionally, but in some embodiments preferably, the magnetic core of the rotor is a toroidal structure made from magnetic ribbons e.g., amorphous alloy or nano-crystalline alloy ribbons, wound to form a spiral of wound ribbon laminations.

The magnetic core of the rotor is mounted on the shaft of the electric machine such that spiral wound ribbon of its magnetic core and the shaft are substantially concentric, so the widths of the rings of the spiral wound ribbon are substantially tangential to the wound spiral. Optionally, but in some embodiments preferably, gaps between successive loops of the spiral magnetic ribbon wound of the magnetic core of the rotor are filled with a non-magnetic material (e.g., air, glue, or nay suitable non-magnetic filler). This way, the magnetic flux produced by the magnetic poles of the stator can easily pass axially through the tangential ring/loop widths of the magnetic core of the rotor, while substantially preventing radial passage of the magnetic flux therethrough and thereby minimizing/preventing magnetic losses.

In some embodiments the toroidal magnetic core structure of the rotor includes a plurality of radially extending grooves formed (e.g., by a cut/abrasive disk) in the annular side facing the stator assembly. The radially extending grooves extend from the inner ring/loop of the rotor magnetic core structure all the way to its outer ring/loop for holding therein an electrically conducting spider structure constituting a secondary winding of the electrical machine. The electrically conducting spider structure can be assembled from concentric electrically conducting inner and outer ring-shaped elements electrically connected one to the other by a plurality electrically conducting spokes radially extending from the inner ring-shaped element to the outer ring-shaped element.

Particularly, in some embodiments the outer electrically conducing ring-shaped element of the spider structure is located over the outer ring/loop of the toroidal magnetic core structure of the rotor, and the inner electrically conducing ring-shaped element of the spider structure is located over (or within) the inner ring/loop of the toroidal magnetic core structure of the rotor. The electrically conducting spokes are implemented in some embodiments by narrow flat electrically conducting plates. The consistency and geometrical dimensions of the narrow flat electrically conducting plates are adapted according to the power of the electric machine and its modes of operation.

Each of the spokes/electrically conducting plates of the spider structure is at least partially accommodated in a respective one of the radially extending grooves of the magnetic core toroidal structure of the rotor. Each plate is electrically connected at one end thereof to the inner ring-shaped electrically conducting element, and at its other end to the outer ring-shaped electrically conducting element, to thereby form the electrically conducting spider structure of the rotor. The electrically conducting inner ring-shaped element, the electrically conducting outer ring-shaped element, and the electrically conducting plate of the spider structure can be fabricated from any suitable electrically conducting material, such as, but not limited to, copper, silver, aluminum.

By changing the shape of the radial grooves formed in the toroidal magnetic core structure of the rotor, and correspondingly the shape and/or thickness of the electrically conducing plates thereby received and held, properties of the electrical machine can be adapted to provide desirous power characteristics and operational frequencies and velocities of the machine. Optionally, but in some embodiments preferably, each electrically conducing plate of the secondary element is configured for accommodating some portion thereof in its respective one of the radial grooves while another portion thereof axially protrudes out of the groove to form a fan blade element. In some embodiments height of the portion of the electrically conducting plate protruding outwardly from the radial groove is about 20 to 40 mm, optionally about 30 mm).

With this rotor configuration the electrically conducting spider structure also serve to ventilate the internal components of the electric machine by the centrifugal fan blade structures formed by the axially protruding plates of the spider structure. During operation, the rotor assemblies and the axial shaft are rotated about the axis of the electrical machine, so the centrifugal fan blade structures formed by the axially protruding plate portions of the spider structure force passage of air streams towards and through the central passage of the stator assembly and over the axial shaft disposed within the central passage of the stator assembly.

Asynchronous axial-gap induction motor embodiments, utilizing magnetic (e.g., amorphous material) ribbons to construct magnetic core elements of the stator and rotor of the motor as disclosed herein, can be operated at a wide range of frequencies of the electric current supply driving the motor. The magnetic cores of the axial-gap motor embodiments disclosed herein are made of amorphous magnetic materials having a substantially low level of magnetic losses, that depending on the frequency of the electrical current passing in their windings, and thus they can be operated at electrical frequencies that are substantially higher than the electrical frequencies typical used in conventional axial-gap rotors having magnetic cores made of steel e.g., losses of magnetic cores made from amorphous magnetic materials at a frequency of 50 Hz are 5 (five) times smaller than the losses in equivalent magnetic cores made of steel.

Therefore, using such amorphous magnetic materials in the magnetic cores of the stator and rotor, enablers operating the rotor in a wide range of operational frequencies, while maintaining a high level of efficiency of the motor e.g., 97%. For example, and without being limiting, the axial-gap electrical machine embodiments disclosed herein may be designed as three-phase motors for electric vehicles. The electric motor can be adapted for operation by an electric power source capable of varying frequencies of the electric currents thereby supplied, for example between 25 Hz to 525 Hz, for which the magnetic losses of the magnetic system are confined with high precision within a desired range.

The inventors hereof conducted full-scale testing of the magnetic core elements of the electric motor designs disclosed herein, through which the following formula was determined for magnetic losses of the motor:

P₀=15.53×B^{1.93}×f^{1.485} W/kg,

where P₀ is the computed value of the magnetic losses in [W/kg] units;

B is the magnetic field induced in the magnetic core in Tesla [T] units; and

f is the frequency of the electric power source in [kHz] units.

For an overview of several example features, process stages, and principles of some embodiments of the presently disclosed subject matter, the examples of axial-gap induction electric machines illustrated schematically and diagrammatically in the figures are mainly intended for axial-gap motors. These motor systems are shown as one example implementation that demonstrates a number of features, processes, and principles used to provide axial-gap electric machines, but they are also useful for other applications and can be made in different variations. Therefore, this description will proceed with reference to the shown examples, but with the understanding that some embodiments of the presently disclosed subject matter recited in the claims below can also be implemented in myriad other ways, once the principles are understood from the descriptions, explanations, and drawings herein. All or most such variations, as well as any other modifications apparent to one of ordinary skill in the art and useful in axial-gap electrical machine applications may be suitably employed, and are intended to fall within the scope of this disclosure.

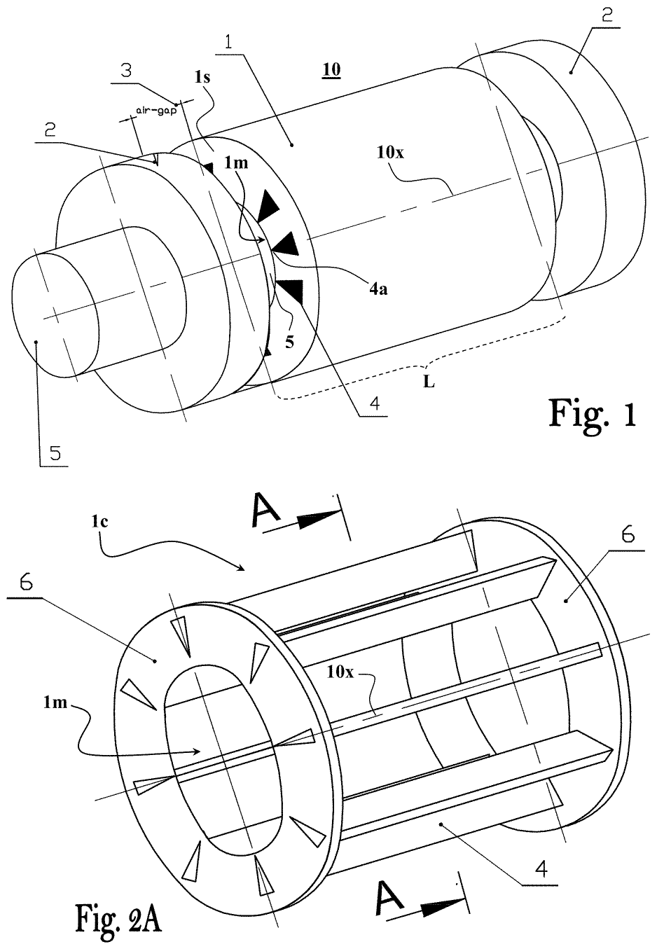

FIG. 1 schematically illustrates a three phase asynchronous motor 10 according to some possible embodiments. The motor 10 includes a cylindrically shaped stator assembly 1 having a concentric cylindrical channel 1m passing therealong, and two disk-shaped rotors assemblies 2. The rotor assemblies 2 are fixedly attached to an axial shaft 5 concentrically passing through the cylindrical channel 1m of the stator assembly 1. The axial shaft 5 and rotor assemblies 2 attached to it constitute the rotor of the motor 10, configured to rotate about the motor axis 10x relative to the stator assembly 1, which remain stationary during operation of the motor 10. In this specific and non-limiting example the motor 10 includes one stator assembly 1 and two rotor assemblies 2, but other configurations can be similarly devised using the principle and techniques disclosed herein (e.g., motors having a single rotor assembly, or two or more stator assemblies and three or more rotor assembles).

The stator assembly 1 includes a plurality of circumferentially distributed stator magnetic core elements 4 passing along the length of the stator 1. The number of stator magnetic core elements 4 provided in the stator assembly 1 depends on number of magnetic poles that can be required in the motor 10. Each stator magnetic core element 4 extend along a length L of the stator assembly 1 substantially parallel to the motor axis 10x, such that each of its end sides is facing a different one of the rotor assemblies 2. A respective air gap 3 is formed between each rotor assembly 2 and a respective annular end side is of the stator assembly 1.

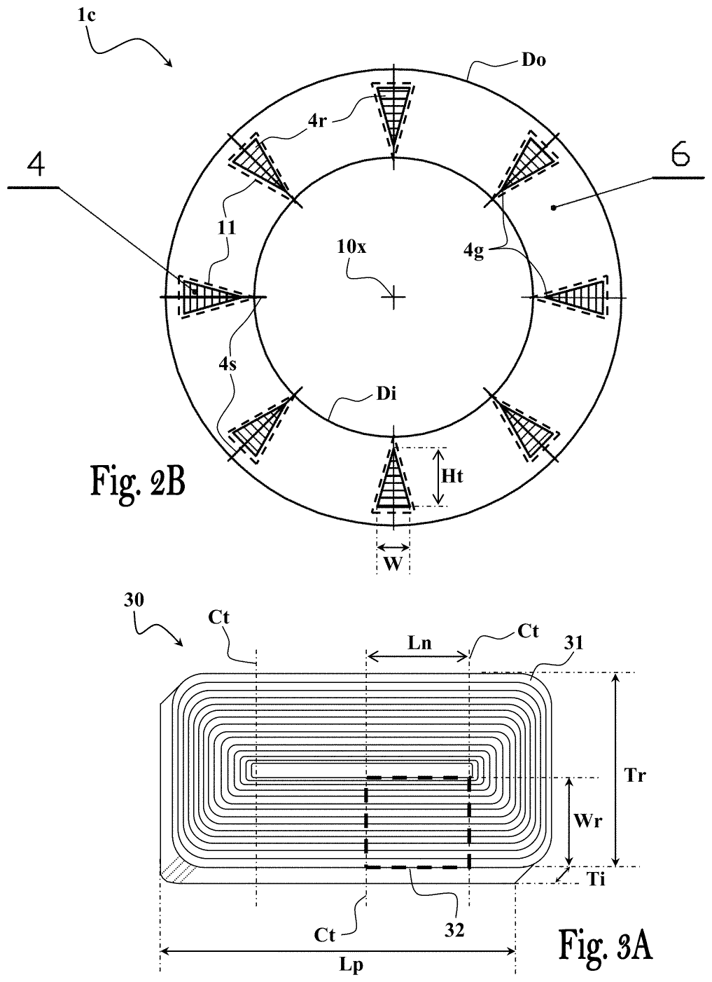

FIG. 2A shows the magnetic core structure 1c of the rotor 10 mounted between two disk-shaped support elements 6. The disk-shaped support elements 6 are made of electrically insulating non-magnetic materials between which the magnetic core elements 4 are firmly secured to form a squirrel-cage structure. The magnetic core structure 1c includes in some embodiments components (not shown) for cylindrical bracing between the disk-shaped elements (e.g., using screws and nuts).

FIG. 2B shows a sectional view of the magnetic core structure 1c of the motor 10. In this specific and non-limiting example the magnetic core structure 1c includes eight magnetic core elements 4, each being triangular in cross-section. Optionally, but in some embodiments preferably, cross-section of the magnetic core elements 4 is of an isosceles triangular shape. The magnetic core elements 4 are evenly distributed circumferentially about the axis of rotation 10x of the motor, such that their apex angles 4g (acute angle if the core elements have isosceles triangular cross-sectional shape) are directed towards the axis of rotation 10x of the motor. The magnetic core elements 4 are located between inner diameter Di and external diameter Do of the disk-shaped elements 6, and they are arranged therein such that axes of symmetry 4s of their triangular-shaped cross-sections radially extend between the inner and external diameters, Di and Do.

The disk-shaped elements 6 can be fabricated from a type of plastic or fiberglass material, such as CTEF, for example. It is noted that if steel disk-shaped elements are to be used instead, the closure of magnetic flux produced by the magnetic core elements involves decrease in induction in the air gap, as well as an increase in magnetic losses. Generally, use of electrically conductive materials in the disk-shaped elements 6 (e.g., aluminum), yields inductive loss processes due to the intersection of the aluminum material with the magnetic flux. Thus, these disk-shaped elements 6 are made from electrically insulating and non-magnetic materials, and they define a circular zone that runs close to the outer diameter of the stator assembly 1. This design guarantees high accuracy parallelism between the intermediate surfaces, and outer end surfaces, of the magnetic core elements 4 of the stator assembly 1, which correspondingly ensures the same level of accuracy and alignment of the end surfaces (at 1s) of the magnetic core elements 4 of the stator assembly 1, and consequently, the accuracy of the air gaps 3 formed between the rotor(s) and the stator(s) assemblies, 2 and 1, respectively.

As seen in FIG. 2B, each stator magnetic core element 4 is a multilayered structure made of magnetic ribbon layers 4r having a gradually decreasing width W towards their apex angle 4g. As also shown in FIG. 2B, an electromagnetic coil 11 wound is placed over each one of the magnetic core elements 4. The electromagnetic coils 11 can be interconnected electrically to provide a desired primary winding element of the stator assembly 1. Each of the magnetic ribbon layers 4r extends in the magnetic core structure 1c substantially parallel to the axis of rotation 10x, such that the magnetic flux produced by the electromagnetic coil 11 passes axially through the magnetic core elements 4 parallel to the axis of rotations and in substantial alignment with direction in which the magnetic ribbon layer 4r extend in the magnetic core elements 4.

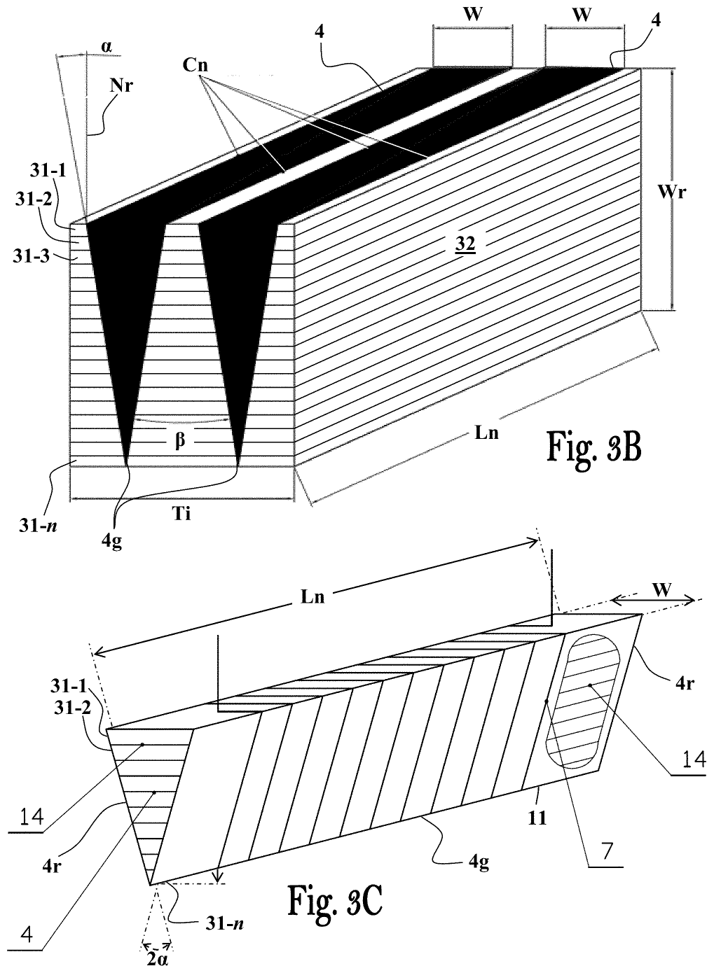

FIGS. 3A to 3C show a process used in some embodiments for fabrication of the stator magnetic core elements 4. With reference to FIG. 3A, a toroidal rectangular-shaped magnetic core piece 30 having a generally rectangular shape is wound from a magnetic ribbon 31 e.g., amorphous material ribbon or nanocrystalline material ribbon. In some embodiments the width Ti of the magnetic ribbon 31 is about 70 to 100 mm, optionally about 80 to 90 mm, optionally about 85 mm, and its thickness is about 36 mm. The length Lp of the rectangular-shaped toroid magnetic core piece 30 can be about 500 to 1000 mm, optionally in a range of 600 to 850 mm, optionally about 720 mm. The width Tr of magnetic core piece 30 can be about 200 to 400 mm, optionally in a range of 250 to 350 mm, optionally about 300 mm. The magnetic ribbon 31 can be made from iron-based materials, for example, and without being limiting, 2605SA1 or 1K101 for electrical current frequencies of about 1 kHz, or from nanocrystalline alloys, for example, and without being limiting, GM414 for frequencies greater than 1 kHz.

During the manufacture of the magnetic core piece 30 slender air gaps are typically formed between adjacently located layers (tapes) of the magnetic ribbon 31, the dimensions of which depends on the winding density of the magnetic ribbon 31. In some embodiments the winding density ratio of the magnetic ribbon 31 is in the range of 0.8 to 0.95, and in this case the sizes of the gaps between adjacently located layers of the magnetic ribbon 31 is typically between 1 to 4 microns (micrometer).

After completing the winding the free end of the magnetic ribbon 31, is firmly attached over the last loop of the wound magnetic ribbon (e.g., by adhesives and/or welding), and the magnetic core piece 30 undergoes thermal treatment and impregnation (e.g., by resin/varnish) to obtain a substantially rigid magnetic core piece 30. For example, the magnetic core piece 30 can be impregnated in glue or varnish material and thereafter dried e.g., in a suitable oven. Thus, in the dried magnetic core piece 30 the gaps between adjacently located layer/tapes of the magnetic ribbon 31 are filled with non-magnetic spacers/fillers i.e., dried glue/varnish material. Optionally, but in some embodiments preferably, the winding density coefficient is taken into account during calculations/design of the properties of the magnetic core elements.

The rigid magnetic core piece 30 is then cut (e.g., by abrasive disk with good quality and high precision of cutting), along cutting lines Ct to obtain rectangular (e.g., parallelepipeds-shaped) magnetic core piece cuts 32. In some embodiments a length (Ln in FIG. 3B) of the magnetic core piece cuts 32 is about 85 to 150 mm, optionally in a range of 100 to 120 mm, optionally about 112 mm. The width Wr of the magnetic core piece cuts 32 can be about 70 to 110 mm, optionally in a range of 85 to 105 mm, optionally about 92 mm. The thickness of the magnetic core piece cuts 32 substantially equals to the width Ti of the magnetic ribbon 31 from which the magnetic core pieces 32 are constructed.

One or more elongated prism-shaped magnetic core elements 4 are then cut out from each magnetic core piece cut 32 (e.g., by an abrasive disk) along the cutting lines Cn, as shown in FIG. 3B. The cutting lines Cn can be applied from a topmost magnetic ribbon layer 31-1 towards a bottommost magnetic ribbon layer 31-n, in a desired slant angle α, to thereby obtain gradual decrease in the width W of the magnetic ribbon layers 31-1, 31-2, . . . , 31-n (collectively referred to herein as magnetic ribbon layers 31) of the magnetic core element 4. The angle α of cutting through the magnetic ribbon layers 31 of the of the magnetic core piece 32, is defined with respect to a normal Nr to the surface of the first/topmost magnetic ribbon layer 31-1, and it defines the apex angle 4g of the stator magnetic core elements 4 to about 2a degrees. In some embodiments the apex angle 2a is about 10° to 30°, optionally about 20°. The length Ln of the magnetic core element 4 is in some embodiments about 85 to 150 mm, optionally in a range of 100 to 120 mm, optionally about 112 mm. The height Wr of the magnetic core element 4 is in some embodiments about 70 to 110 mm, optionally in a range of 85 to 105 mm, optionally about 92 mm. A width W of the magnetic core element 4 is about 20 to 40 mm, optionally in a range of 30 to 38 mm, optionally about 36 mm.

After cutting out the magnetic core elements 4 from the magnetic core pieces 32, one or more coils 11 are fitted/wound over each magnetic core element 4. FIG. 3C shows the magnetic core element 4 with windings 7 of a coil 11 placed thereover. Each magnetic core element 4 is then attached (e.g., glued by epoxy adhesive) between the disk-shaped support elements 6 of the stator, as shown in FIGS. 2A and 2B. In additional the disks 6 can be interconnected by rods and/or by several cylindrical spacers made of stainless steel and disposed circumferentially on the outer diameter of the stator.

This fabrication process of the magnetic core elements 4 can be similarly used to construct stator magnetic core structures 1c having any suitable number of magnetic poles. For example, and without being limiting, the 2α apex angle 4g is in some embodiments an acute angle adjusted according to the number of magnetic poles of the stator assembly 1. In possible embodiments the stator assembly 1 is configured to accommodate a three-phase coil system having four magnetic poles, for which the 2α apex angle 4g of each magnetic core element 4 is about 30°. In other possible embodiments the stator assembly 1 is configured to accommodate a three-phase coil system having six magnetic poles, for which the 2α apex angle 4g of each magnetic core element 4 is about 20°. Accordingly, the 2α apex angle 4g of each magnetic core element 4 can be generally defined by the expression 2α=120°/m, wherein m is the number of magnetic poles of the stator assembly 1.

As seen in FIGS. 2B, 3B and 3C, with this fabrication technique of the magnetic core elements 4 a longitudinal arrangement of the magnetic ribbon layers 31 in parallel to the long axis of the magnetic core elements 4, and thereby also in parallel to the axis of rotation of the motor, is achieved in the magnetic core structure 1c. This arrangement of the magnetic ribbon layers 31 in the magnetic core elements 4, and of the magnetic core elements 4 in the stator assembly 1, guarantees that the magnetic flux lines produced by the coils 11 are substantially aligned, and substantially coincide, with the direction of the magnetic ribbon layers 31, which substantially minimizes the magnetic losses in the magnetic core structure 1c.

Accordingly, the magnetic core structure 1c obtained is included of a set of rigid magnetic core elements 4 carrying respective coils 11 and having substantially low magnetic losses. The coils 11 placed over the magnetic core elements 4 are interconnected to form a three-phase coil system, and thereby produce a rotating magnetic field that is passed to the rotor assemblies 2 through the axial gaps 3.

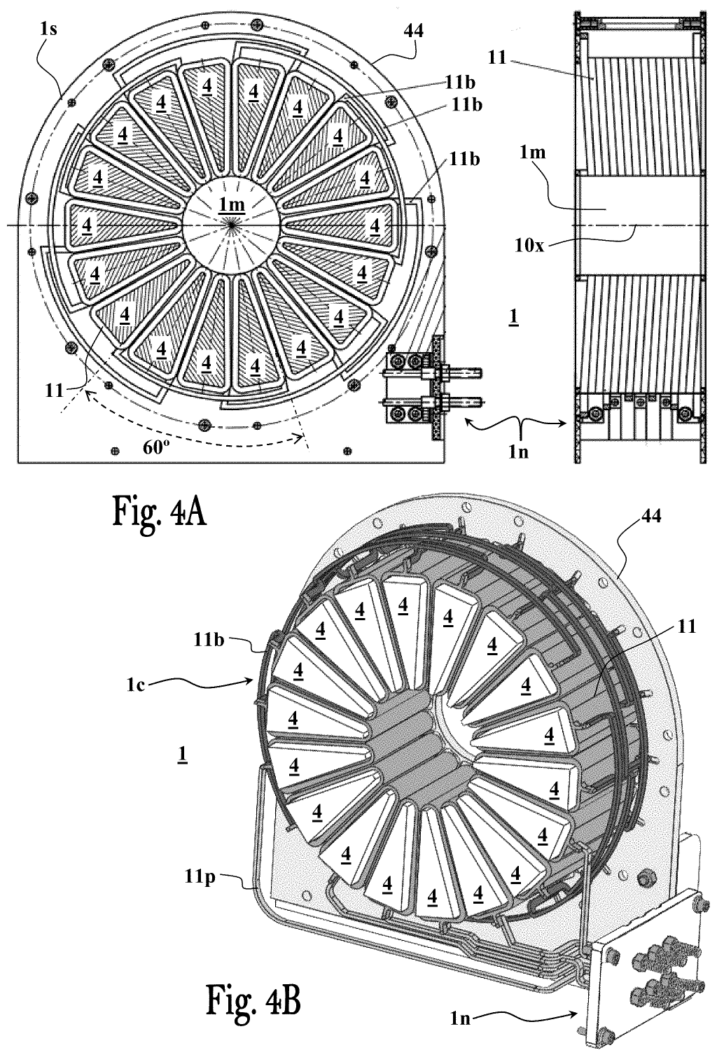

FIG. 4A shows cross- and longitudinal-sectional views, and FIG. 4B shows a perspective view, of the stator assembly 1 according to some possible embodiments attached (e.g., by screws and/or bolts) to a stator support plate 44. In this specific and non-limited example the stator assembly 1 includes 18 (eighteen) prism-shaped magnetic core elements 4, each having at least one coil 11 mounted thereover. The magnetic core elements 4 are evenly circumferentially distributed about, and substantially parallel to, the axis of the motor 10x. Optionally, but in some embodiments preferably, the magnetic core elements 4 are constructed from magnetic ribbons (31) as described herein-above with reference to FIGS. 3A to 3C, and they arranged inside the stator assembly 1 such that their magnetic ribbons (31) are substantially parallel to the axis of the motor 10x to coincide with the magnetic flux lines (not show) produced by the coils 11.

In this stator configuration the coils 11 are electrically interconnected by electrical conductors, such as bus-bars 11b, passing along circumferential sections extending about the magnetic core structure 1c to form a three-phase coil system configured to set 6 (six) magnetic poles of the stator assembly 1. Particularly, each group of 6 (six) coils 11 that are 60° spaced apart in the annular magnetic core structure 1c are electrically connected in series and powered during operation by one phase of a three-phase power supply, to thereby set the 6 (six) magnetic poles of the motor. Each group of 6 (six) serially connected coils 11 is electrically connected at one end thereof to a power supply conductor/bus-bar 11p connecting the group of serially connected coils 11 to the electrical contacts assembly 1n of the motor for receiving electrical current from a three-phase power supply (not shown), and at another end thereof to another power supply conductor/bus-bar 11p for passing the return current from the group of serially connected coils 11 to the electrical contacts assembly 1n of the motor.

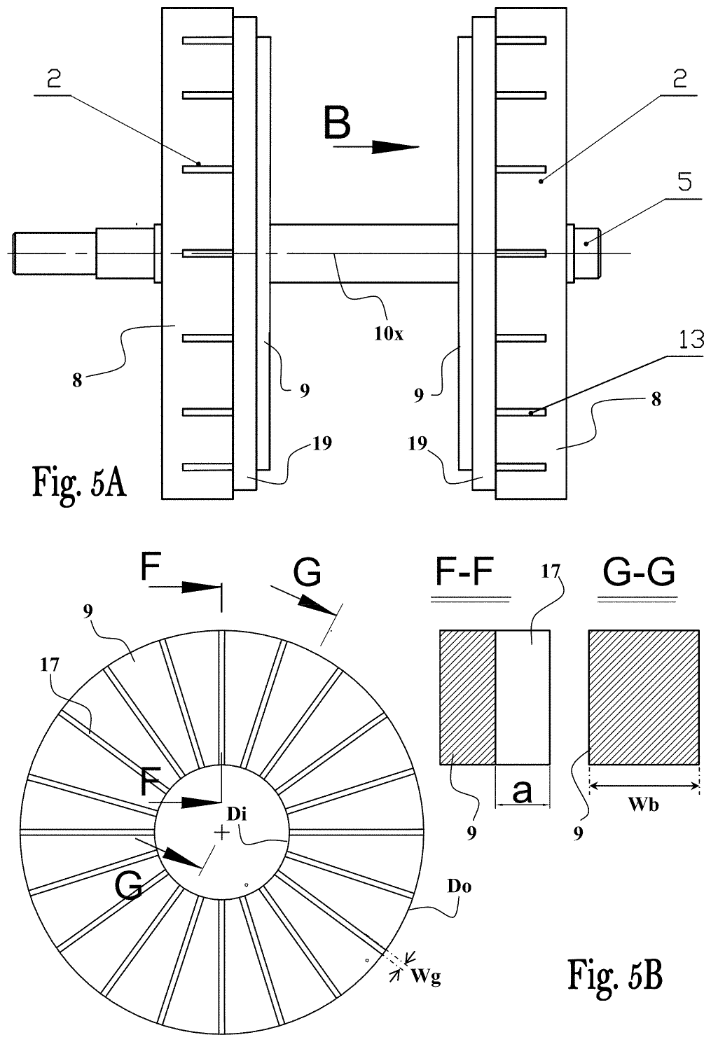

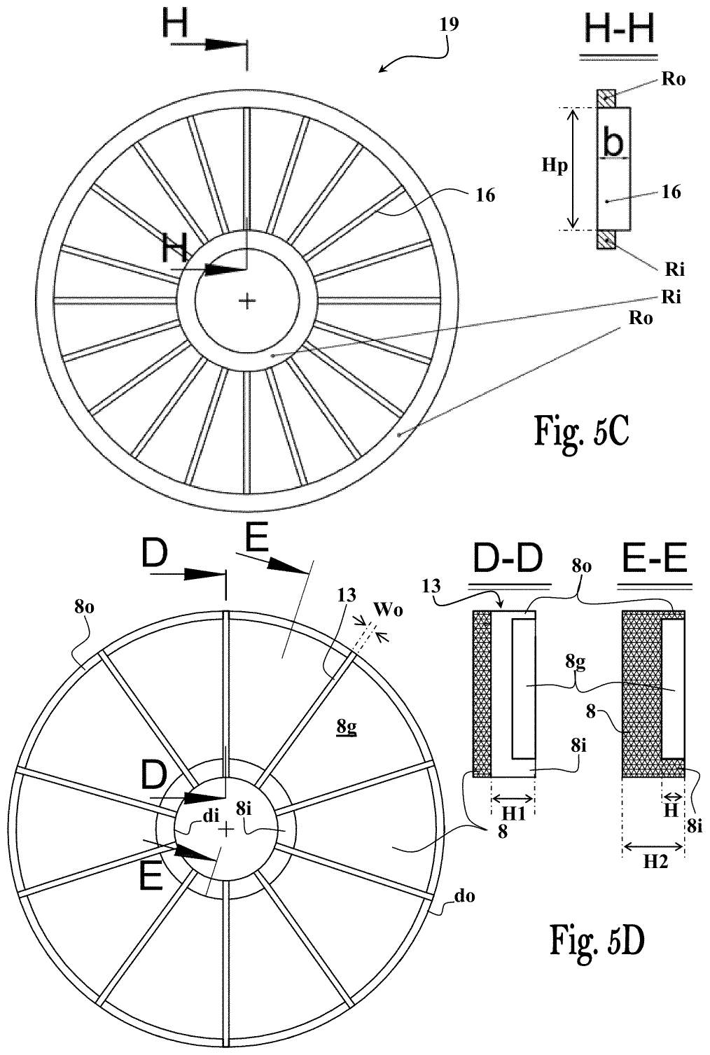

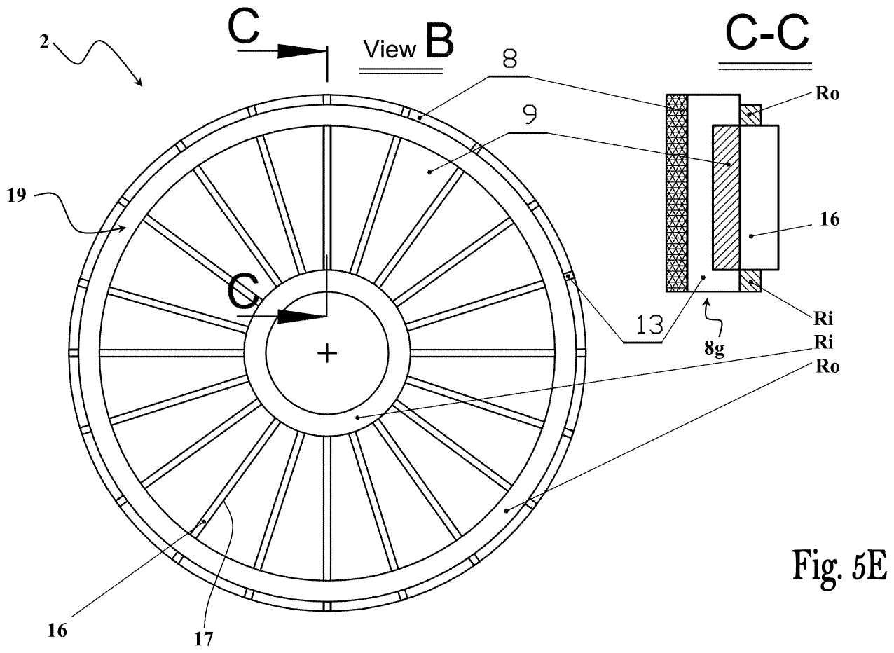

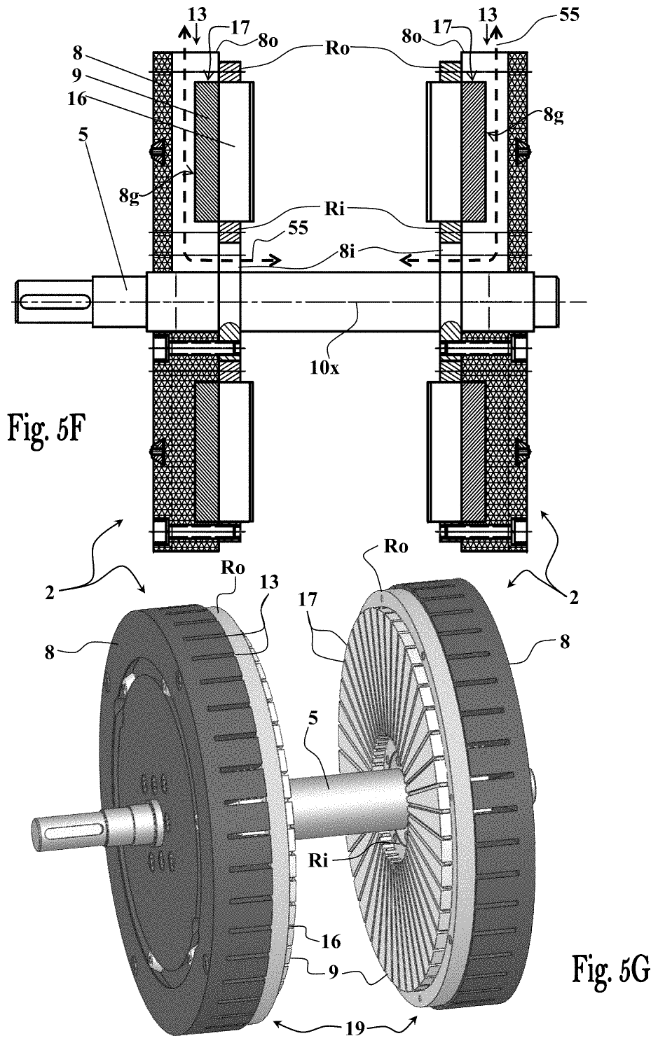

FIG. 5A shows arrangement of two rotor assemblies 2 concentrically attached to the shaft 5 of the motor according to some possible embodiments. Each rotor assembly 2 includes a disk-shaped base element 8 made of a nonmagnetic and electrically insulating material, a rotor toroidal magnetic core 9 at least partially accommodated within an angular cavity (8g in FIG. 5D) of the base element 8, and a secondary winding structure (an electrically conducting spider assembly) 19 received and held in radial grooves (17 in FIGS. 5B and 5E) of the base element 8, as will be described below in details. The secondary winding structure 19 includes a plurality of radially extending electrically conducting spokes (16 in FIG. 5C). Optionally, but in some embodiments preferably, the locations and orientations of the electrically conducting spokes aligns the lengths of the spokes (Hp in FIG. 5C) of the secondary winding structure 19 with the heights (Ht in FIG. 2B) of the triangular cross-sections of the magnetic core elements 4 of the stator assembly 1. The coupling between the stator assembly 1 and the rotor assembly 2 can be optimized by setting the heights (Ht) of the triangular cross-sections of the magnetic core elements 4 to coincide with the lengths of the spokes (Hp) of the secondary winding structure 19, to thereby ensure maximal interaction between the rotor and stator assemblies i.e., by having Hp≈Ht.

FIG. 5B shows a front view of the magnetic core 9 of the rotor 2, according to some possible embodiments. The magnetic core 9 is made in some embodiments from magnetic ribbons (e.g., made of amorphous alloy or nanocrystalline alloy) wound to form a toroidal core structure having an inner diameter Di (e.g., of about 60 to 80 mm) and an outer diameter Do (e.g., of about 230 to 280 mm). After winding the toroidal structure, the magnetic core 9 undergo thermal treatment and impregnation (e.g., by resin/varnish), and it is then dried (e.g., in an oven) to obtain a substantially rigid rotor magnetic core 9. As described hereinabove, in this process slender gaps are formed between adjacently located loops of the wound magnetic ribbon, which filled by the nonmagnetic materials during the impregnation and drying processes.

A plurality of radial grooves 17 are then formed (e.g., from the inner diameter Di to the outer diameter Do) in the front side (i.e., the side facing the stator assembly) of the rigid magnetic core 9. Each radial groove 17 extends between the inner diameter Di and the outer diameter Do of the magnetic core 9, and configured to receive at least a portion of a respective narrow flat electrically conducting plate/spoke (16 in FIGS. 4C and 4E) of the spider/electrically shorted secondary winding 19 assembly.

FIG. 5B further shows sectional views of magnetic core 9 taken along lines F-F and G-G. The width Wb of the magnetic core 9 substantially equals to the width of the magnetic ribbon from which the magnetic core 9 is wound, which is in some embodiments about 35 to 45 mm, optionally about 40 mm. The thickness of the magnetic ribbon used to construct the magnetic core element 9 is in some embodiments about 25 microns. The magnetic ribbon of the magnetic core 9 of the rotor assembly can be a type of amorphous ribbon, for example e.g., made of 1K101 material. The depth a of the radial grooves 17 is in some embodiments about 20 to 30 mm, optionally about 22.5 mm. The width Wg of the radial grooves 17 can be about 2 to 3 mm, optionally about 2.5 mm. In this configuration, the thickness of the spokes/plates 16 placed in the radial grooves 17 can be in the range of 2.25 to 2.75 mm, optionally about 2 mm, and their lengths (Hp in FIG. 5C) can be in the range of 15 to 25 mm, optionally about 20 mm. The toroidal magnetic core element 9 of the rotor assembly has an inner diameter Di, which is in some embodiments in the range of 70 to 90 mm, optionally about 80 mm, and an outer diameter Do, which is in some embodiments in the range of 220 to 280 mm, optionally about 250 mm.

FIG. 5C shows a front view of the spider assembly 19 including according to some possible embodiments an inner electrically conducting ring Ri, and outer electrically conducting ring Ro, and a plurality of the electrically conducting plates 16 radially extending therebetween. The ends of the electrically conducting plates 16 are connected to the electrically conducting rings, Ri and Ro. The inner electrically conducting ring Ri can be configured to align with the inner diameter Di of the magnetic core element 9 of the rotor, and the outer electrically conducting ring Ro can be configured to align with the outer diameter Do of the magnetic core 9 element. The electrically conducting plates 16 are thus electrically connected to the electrically conducting rings Ri and Ro (e.g., by welding), thereby constituting an electrically shorted secondary winding of the rotor.

FIG. 5C further shows a sectional view of the spider assembly 19 taken along the line H-H. The width b of the electrically conducting plates (e.g., narrow flat strips) 16 is in some embodiments about 15 to 25 mm, optionally about 20 mm. The plates 16, and the inner and outer rings Ri and Ro can be fabricated from any suitable electrically conducting material, such as but not limited to, Copper, Brass, or Aluminum. The choice of material of the plates 16 and rings Ri and Ro depends in some embodiments on the power of the motor and its modes of operation. The thickness of the plates 16 can be in the range of 1.5 to 2.5 mm, optionally about 2 mm. In some embodiments the end portions of the plates 16 axially protrude (about 20 to 40 mm) from the radial grooves 17, thereby forming ventilation fan blades.

FIG. 5D shows a front view of the disk-shaped base element 8 having inner annular lip 8i and outer annular lip 8o upwardly protruding from the front surface of the disk-shape base element 8 and forming an annular cavity 8g therebetween. The annular cavity 8g formed in the disk-shaped base element 8 is configured to receive and hold the magnetic core element 9 or the rotor 2 with the spider assembly (the electrically shortened secondary winding) 19 thereby carried. The disk-shaped base element 8 can be prepared from any suitable electrical insulating and non-magnetic materials, such as but not limited to, plastic, or fiberglass, for example, STEF grade fiberglass, e.g., by casing, molding, engraving.

The disk-shaped base element 8 of the rotor further includes a system of ventilation channels 13 radially extending between, and slotting, the inner and the outer annular lips, 8i and 80. The ends of the radial channels 13 radially cutting through the outer annular lips 8o are in fluid communication with the cylindrical concentric channel (1m) extending through the stator assembly and around the motor shaft (5), and their opposite side ends radially cutting through the outer annular lips 8o are in fluid communication with the outer volume of the motor e.g., enclosed within a housing of the motor. Thus, each radial channel 13 formed in the disk-shaped base element 8 facilitates passage of air between the outer volume of the motor and its cylindrical concentric channel (1m), which serves for cooling of the motor during its operation.

The radial channels 13 acts as a centrifugal fan blade configured for cooling the motor by air streamed by the blades of the centrifugal fan formed by the plates 16 of the rotor assembly, thereby forming an internal ventilation system within the motor 10. In this specific and non-limiting example the disk-shaped base element 8 includes 10 (ten) radial channels 13. However, any suitable number of radial channels 13 can be formed in the disk-shaped base element 8 per design requirements and specification i.e., the number of radial channels 13 can be greater or smaller than ten.

The number of radial ventilation channels 13, and their geometrical dimensions depend on the power of the motor. For example, and without being limiting, the number of ventilation channels 13 passing under the toroidal magnetic core element 9 may be 8 (eight). FIG. 5D further shows sectional views of the disk-shaped base element 8 taken along the line D-D passing through one of the radial channels 13, and the line E-E passing between two neighboring radial channels 13. The width 112 of the disk-shaped base element 8 is adapted in some embodiments to accommodate the radial channels 13 formed therein e.g., about 7 to 25 mm. The depth H1 of the radial channels 13 is in some embodiments about 5 to 10 mm, and their widths Wo can be in the range 5 to 15 mm. The depth H of the annular cavity 8g is adapted in some embodiments to at least partially accommodate the rotor toroidal magnetic core 9 therein e.g., about 2 to 12 mm. The inner diameter of the disk-shaped base element 8 is in some embodiments about 70 to 90 mm, optionally about 80 mm. In some embodiments the outer diameter do of the disk-shaped base element 8 is about 250 to 310 mm, optionally about 280 mm.

FIG. 5E is a front view of the rotor assembly 2 showing the disk-shaped base element 8 with the magnetic core element 9 mounted in its annular cavity 8g, and with the spider assembly 19 having its electrically conducting plates 16 mounted in the radial grooves 17 of the magnetic core element 9. The magnetic core 9 of the rotor assembly 2 is mounted in the disk-shaped base element 8 for facing an annular face of stator assembly (1) and form the axial airgap (3) between the stator assembly (1) and the rotor assembly 2. In some embodiments at least some portion of each electrically conducting plate 16 outwardly protrudes from its respective radial grooves 17, thereby forming a plurality of ventilation fan blades for removing heat from the magnetic core and windings by centrifugal air circulation obtained during operation of the motor.

The ventilation fan blades further facilitate ventilation of the stator assembly by streaming air through the radial channels 13 of the disk-shaped base element 8 of each rotor assembly 2. This way, the disk-shaped rotor assemblies 2 create together an internal ventilation system within the motor 10 during its operation. The ventilation channels 13 connect inner zones of the rotor within the inner diameter di with the outer zones/environment of the motor about the outer diameter of the rotor do, and thereby create a two-sided ventilation system for the motor, which is seen in FIG. 5F.

In some embodiments the inner and outer electrically conducting rings, Ri and Ro, of the spider element 19 are soldered to the electrically conducting plates 16 at their extremities, and the inner and outer electrically conducting rings, Ri and Ro, are attached (e.g., by screws) to the disk-shaped base element 8 to place at least portion of the electrically conducting plates 16 floating inside their respective radial grooves 17, such that there is no direct contact between the electrically conducting plates 16 and the magnetic core element 9 of the rotor assembly 2 i.e., each of the electrically conducting plates 16 is floating in its respective radial 17.

FIG. 5G shows a perspective view of the motor shaft 5 with two rotor assemblies 2 according to some possible embodiments. In this specific and non-limiting example each rotor disk-shaped base element 8 includes 48 (forty-eight) radial ventilation channels 13, and each rotor magnetic core element 9 also includes 48 (forty-eight) radial grooves 17. In addition, in this exemplary embodiment the electrically conducting plates 16 of the electrically conducting spider assembly 19 are entirely disposed within their respective radial grooves 17 i.e., they don't axially protrude from the surface of the rotor magnetic core 9.

FIG. 5F shows a sectional view of the motors' shaft 5 with two rotor assemblies 2 mounted thereon. As seen in FIG. 5F, the radial channels 13 formed in the disk-shaped base elements 8 of the rotor assemblies 2 are open at the outer diameter (at 80) of the rotor 2 to the a volume/environment outer to the rotor assemblies 2, and at their inner diameters (at 8i) to an inner volume of the stator assembly 1 enclosed along a portion of the shaft 5 between the rotor assemblies 2 by the concentric cylindrical channel (1m) of the stator assembly (1). This way a plurality of air passages 55 are formed through each rotor assembly 2 between outer volume/environment and the inner volume of the rotor.

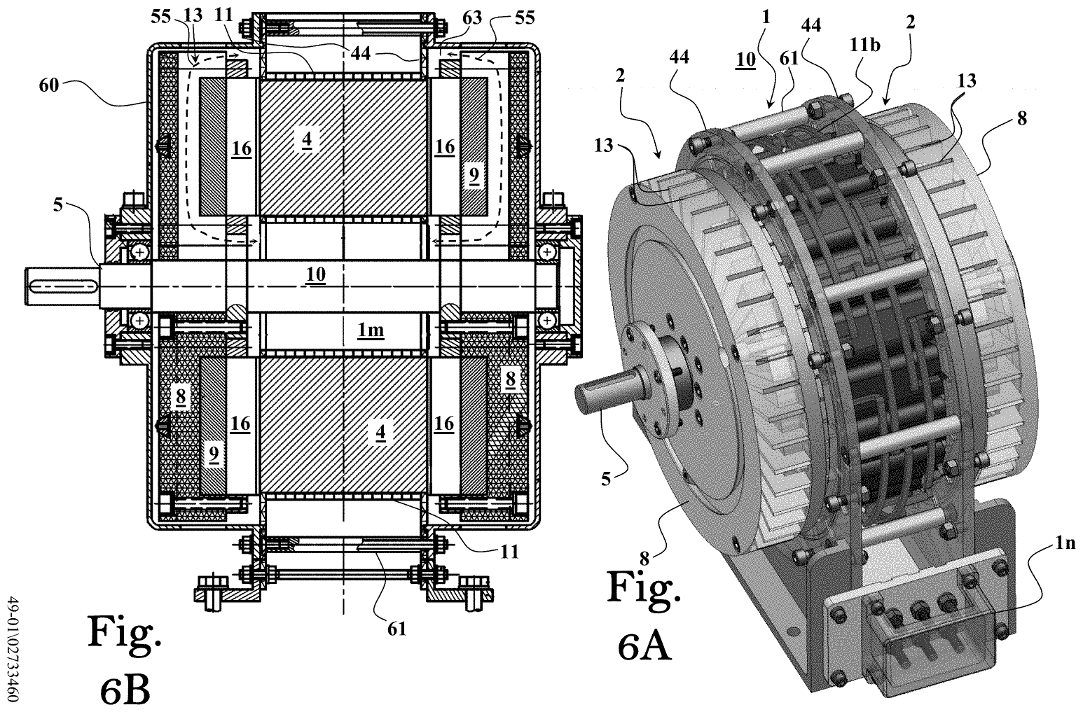

FIG. 6A shows a perspective view of the motor 10 according to some possible embodiments, after the motor shaft 5 is passed through the concentric cylindrical channel (1m) of the stator assembly 1, and two stator support plates 44 are attached by studs 61 over the sides of the stator assembly 1. FIG. 6B shows a sectional view of the motor 10 enclosed in some embodiments inside housing 60. The shaft 5 can be connected to the housing and/or to the stator support plates 44 by bearings. As also seen, the radial ventilation channels 13 of the disk-shaped base elements 8 of the rotor assemblies 2 provide a plurality of air passages 55 between outer annular 63 cavities formed within the housing 60 and the concentric cylindrical channel 1m of the stator assembly 1.

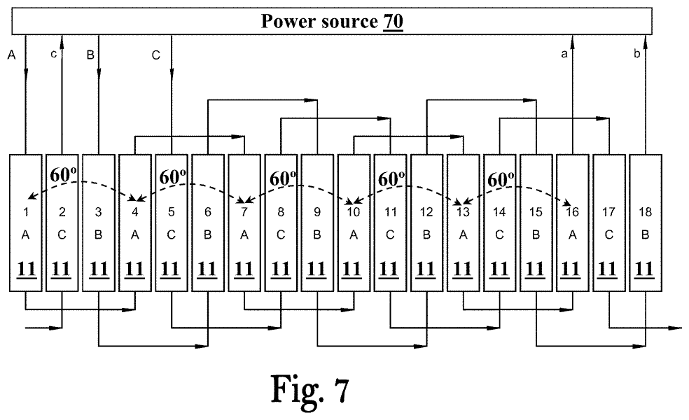

FIG. 7 schematically illustrates electrical connectivity of the coils 11 placed over the magnetic core elements (4) of the stator assembly 1, according to some possible embodiments. The coils 11 are arranged into group A, group B, and group C, wherein the coils 11 of each group are 60° spaced apart about the axis (10x) of the motor. The coils 11 of each group are electrically connected each to other in series to form a three-phase coil system in which the coils 11 are electrically out-of-phase from each other. In operation, each group of the coils 11, A, B and C, is electrically connected to a respective electrical phase of a three-phase power supply 70.

The three-phase electrical current supplied to the coils 11 generates an alternating rotating magnetic field in the magnetic system of the stator assembly (1). The magnetic field emerges from the extremities of magnetic core elements (4) of the stator into the axial air-gaps (3), and interacts with the magnetic core (9) and the electrically conducting spider assembly (19 i.e., electrically shortened secondary winding) of the rotors (2). The alternating magnetic fields induced in the rotors (2) generate electrical currents in the plates (16) of the spider assemblies (19), which in effect produce a counter rotating magnetic field in the rotor (2).

The magnitude of the electric currents evolving in the plates (16) depends on the power of the motor. For example, for a motor power of 50 kVA the electrical currents in evolving the rotor is about 72 A. These currents produce the torque of the rotor assemblies (2). Since the rotor assemblies (2) are mounted on a common shaft 5, their produced torques rotates the shaft 5 in the direction of the rotating magnetic field produced by the stator assembly (1). The angular speed of the rotor assemblies can be adjusted by changing the frequency of the three-phase power supply 70. In some embodiments the frequency of the power supply 70 is changed between 25 Hz to 525 Hz to affect variable angular velocities.

The motor embodiments disclosed herein are designed to work in different operational modes. The start mode (nominal power mode, as well as the maximum speed mode, can be defined within the range of operating electrical frequencies of the motor. Therefore, the power supply used in some embodiments is an electric current of variable frequency, for example, in the range of 25 to 525 Hz, which provides the following rotation speeds: at a frequency of 250 Hz-the rotation speed is about 5000 revolutions per minute (rpm), at a frequency of 25 Hz-about 500 rpm, and at a frequency of 525 Hz-the rotation speed is about 10500 rpm.

The motor embodiments disclosed herein, operated by electric currents of variable frequency to adjust the torque, speed of rotation, and electromagnetic characteristics of the motor, can be advantageously used in electric vehicles. One of the most important characteristics of many important characteristics of the motor is the coefficient of efficiency, which depends on the level of electromagnetic losses in the magnetic core and windings of the motor. Since in in some embodiments the magnetic core elements (4 and 9) of the stator and rotor (1 and 2 respective) are constructed from magnetic ribbons made from amorphous materials, the induction and the corresponding level of magnetic losses are selected high level of efficiency in all or most modes of operation of the motor e.g., about 97%. Such high levels of efficiency cannot be achieved in conventional asynchronous motors designs.

The inventors hereof found out that the value of the magnetic losses in different parts of the magnetic core elements of the motor that are constructed from amorphous material ribbons (e.g., 2605SA1) can be determined by the following expression:

Pₒ=15.53×B^{1.93}×f^{1.485} (1)

where Pₒ is the computed value of the magnetic losses in [W/kg], B is the magnetic field induced in the magnetic core elements in [Tesla], and f is the frequency of three-phase electric supply in [kHz]. In accordance with expression (1), magnetic losses in magnetic core elements/circuits of the stator and rotor assemblies were calculated. In this case, the calculations of inductions in magnetic circuits were carried out according to the usual method. In the manufacture of such magnetic core element, the following operations were carried out: winding amorphous ribbon/tape on a mandrel, impregnation with glue or varnish, drying in a furnace and cutting with an abrasive disc.

### Example 1

The following process can be used in manufacture of linear stator magnetic core elements having a triangular cross-sectional shape with a length Ln of about 112 mm, height Wr of about 85 mm, apex angle of about 20°, and width W of the topmost magnetic ribbon layer 31-1 (i.e., the layer opposite to the apex angle 4g) of about 36 mm: an amorphous magnetic ribbon 31 having a width Ti, (i.e., defining the height of the magnetic core piece 30) of about 85 mm is wound into a rectangular-shaped toroidal structure (e.g., as shown FIG. 3A) having a length Lp of about 500 to 1000 mm and a width Tr of about 200 to 400 mm. Thereafter, free end of the magnetic ribbon 31 is firmly attached to last loop, the rectangular-shaped toroidal structure 30 undergoes thermal treatment, impregnated in resin/varnish and dried. The toroidal magnetic core structure 30 is then cut by an abrasive disk along the cutting lines Ct to obtain two or more rectangular cuts 32, having a length Ln of about 112 mm, and a width Wr. Then we cut the prism data into rectangular elements, the length of which is already equal, for example, 112 mm, and a width of the side width Wr of the magnetic core structure 30.

One or more prism-shaped magnetic core element 4 are then cut out from each rectangular magnetic core cut 32 by abrasive disk operated with a slant angle of about 10° to the normal Nr to the topmost magnetic ribbon layer, to process a first lateral side of the rectangular magnetic core cut 32. Thereafter, the abrasive disk is turned by 20° in the opposite direction to process the second lateral side of the rectangular magnetic core cut 32, to thereby obtain a linear triangular magnetic core 4.

The magnetic core 9 of the rotor is a toroidal structure made from wound magnetic ribbon (e.g., amorphous ribbon, for example, made of 1K101 material) having a ribbon width of about 40 mm, and thickness of about 25 microns. The inner diameter Di of the toroidal magnetic core element 9 is about 80 mm, and its outer diameter Do is about 250 mm. In order to provide the toroidal magnetic core element 9 solidity, it is impregnated with glue or varnish, and thereafter dried in an oven. Winding density of the toroidal magnetic core element 9 can be in the range of 0.85 to 0.95, such that the gaps formed between adjacently located magnetic ribbon loops/layers are in a range of 1 to 4 microns. After impregnation and drying, these gaps are filled with dried glue or varnish.

Radial grooves are then formed in the toroidal magnetic core element of the rotor, and the spokes/plates of the short-circuited rotor secondary winding are placed in the formed grooves, such that they face the magnetic core elements of the stator after the rotor assembly is attached to the shaft. The number of grooves and their sizes can be selected according to the power of the motor. For example, in some embodiments the groove width is about 2.5 mm, and its depth is about 22.5 mm. The secondary winding of the rotor can be made of copper, using plate having thickness of about 2 mm and a width (b in FIG. 5C) of about 20 mm.

The width of the plates in this case is 20 mm less than the width of the magnetic ribbon/tape from which the toroidal magnetic core element of the rotor is wound. Therefore, the magnetic flux produced by the stator assembly passes into the toroidal magnetic core element of the rotor in a depth, which is greater than the depth of the radial grooves formed in the magnetic core element of the rotor, and therefrom to successive layers of the magnetic ribbon/tape of the toroidal magnetic core element. In this configuration the path of the magnetic flux passing through the toroidal magnetic core element of the rotor has the lowest magnetic resistance, and the smallest magnetic losses.

Magnetic flux paths that are perpendicular to the plane of the ribbon/tape from which the toroidal magnetic core element of the rotor is wound, are not considered, because the total amount of nonmagnetic gaps in the toroidal magnetic core element is significantly large e.g., about 2 to 6 mm in total. In this case, the magnitude of the magnetic resistance for such perpendicular magnetic flux reaches substantially large values, and therefore the magnitude of the radial magnetic flux is substantially zeroed.

### Example 2

Specific magnetic losses are calculated by equation (1) above for a three-phase asynchronous motor with following characteristics:
Motor power of 47 kW,
Variable rotational speed in the range from 500 to 10,500 rpm
Variable frequency of the three-phase AC power supply (70) is in the range of 25 to 525 Hz.

The specific magnetic losses for different parts of the magnetic circuits are first determined using equation (1) at a frequency of f=25 Hz, for which the magnetic field produced by the stator poles is Ban, =1.494 [Tesla], as follows:

Pₒₚₒ₁=15.53×B^{1.93}×f^{1.485}=15.53×1.494^{1.93}×25^{1.485}=0.141 [W/kg]

The magnetic field induced in the teeth portions (i.e., between the radial grooves 17) of the magnetic core elements of the rotors is B_{Z2}=1.511 [Tesla], for which the corresponding specific magnetic losses in the rotor are:

P_{0Z2}=15.53×B^{1.93}×f^{1.485}=15.53×1.511^{1.93}×25^{1.485}=0.145 [W/kg]

The magnetic field induced in the base portion (i.e., the core potion not including radial grooves 17) of the magnetic core of the rotor is B_{Y2}=1,487 [Tesla], for which the computed specific magnetic losses are:

P_{0Y2}=15.53×B^{1.93}×f^{1.485}=15.53×1.487^{1.93}×25^{1.485}=0.141 [W/kg].

Accordingly, based on the weight of each portion of the magnetic circuit of the rotor, the total magnetic losses can be computed, depending on the operating frequency used. In the above example the operating frequencies of 250 Hz, 150 Hz, 25 Hz, 125 Hz and 525 Hz, are considered, for which the total magnetic losses of the magnetic circuit of the rotor are: 60.24 [W]; 76.0 [W]; 5.4 [W]; 55.25 [W]; and 42.72 [W], respectively. Considering the reduced values of the magnetic closes one of the basic parameters of the motor, the efficiency, can be determined, which will be equal at the given operating frequency to: 97.32%; 96.69%; 79.6%; 95.3%; 97.36%, respectively.

The use of amorphous materials for the manufacture of the magnetic core elements (including a plurality of magnetic ribbon layers extending along its length) of the stator and rotor assemblies allows raising the operating frequency of the motor to within the range of 25 to 525 Hz. In additional, the embodiment disclosed herein significantly reduce/minimize the magnetic losses of the cores, allow significant reduction in the geometrical dimensions and weight of the motor, and a high efficiency, of the order of 97%. It was found that the preservation of the above parameters at the right level greatly depends on the geometry of electrically conducting plates 16 constituting the secondary winding of the motor, and also on the operating frequency.

As described hereinabove and shown in the associated figures, some embodiments of the presently disclosed subject matter provides a three-phase axial-gap motor and related methods of design thereof. While particular embodiments of the presently disclosed subject matter have been described, it will be understood, however, that some embodiments of the presently disclosed subject matter is not limited thereto, since modifications may be made by those of ordinary skill in the art, particularly in light of the foregoing teachings. As will be appreciated by one of ordinary skill in the art, some embodiments of the presently disclosed subject matter can be carried out in a great variety of ways, employing more than one technique from those described above, all without exceeding the scope of some embodiments of the presently disclosed subject matter.

1. A stator assembly for an axial-gap electric machine, said stator assembly comprising:
a plurality of prism-shaped magnetic core elements, each of said prism-shaped magnetic core elements comprising a plurality of magnetic ribbon layers extending along its length;
a plurality of coils constituting a primary winding of said axial-gap electric machine, each of said coils mounted over one of said prism-shaped magnetic core elements; and
a support structure configured to fixedly hold said prism-shaped magnetic core elements circumferentially arranged therewithin about and parallel to an axis or rotation of said electric machine, such that an apex angle of said prism-shaped magnetic core elements is directed towards said axis of rotation, and planes of symmetry of said prism-shaped magnetic core elements radially extends from said axis of rotation.

2. The stator assembly of claim 1 wherein cross-sectional shape of each prism-shaped magnetic core element is substantially of an isosceles triangle having an acute apex angle.

3. The stator assembly of claim 1 wherein the support structure comprises two electrically non-conducting and non-magnetic disk-shaped support elements, and wherein the prism-shaped magnetic core elements are attached between said disk-shaped support elements substantially perpendicularly thereto.

4. The stator assembly of claim 1 wherein the magnetic ribbon layers are made of amorphous or nano-crystalline magnetic material.

5. The stator assembly of claim 1 comprising electrical conductors interconnecting between the coils to form a three-phase coil system and configured to provide a determined number of magnetic poles to said stator assembly by connecting it to a three-phase electric power supply.

6. The stator assembly of claim 1 comprising eighteen prism-shaped magnetic core elements.

7. The stator assembly of claim 6 wherein interconnections between the coils by the electrical conductors forms six magnetic poles.

8. A rotor assembly for an axial-gap electrical machine comprising the stator assembly of claim 1, said rotor assembly comprising:
a toroidal-shaped magnetic core element formed from a spiral wound of magnetic ribbon, said toroidal-shaped magnetic core element comprising a plurality of radial grooves extending between inner and outer rings of its spiral wound ribbon; and
a spider-shaped electrically conducting structure constituting a secondary winding of said axial-gap electrical machine, said electrically conducting spider structure comprising a plurality of electrically conducting spokes radially extending between concentric inner and outer electrically conducing rings electrically connected to said spokes, each of said electrically conducting spokes configured to be received at least partially in a respective one of the radial grooves of said toroidal-shaped magnetic core element.

9. The rotor assembly of claim 8 wherein each of the electrically conducting spokes is implemented by an electrically conducting plate radially extending between said concentric inner and outer electrically conducing rings.

10. The rotor assembly of claim 9 wherein a portion of each of the electrically conducting plates protrude outwardly from the respective radial groove of the toroidal-shaped magnetic core in which it is placed, to thereby stream air towards the stator assembly during operation of the axial-gap electrical machine.

11. The rotor assembly of claim 9 wherein geometrical dimensions of the electrically conducting plates is selected to set a defined efficiency factor of the axial-gap electrical machine.

12. The rotor assembly of claim 8 comprising a disk-shaped base element made of a nonmagnetic and electrically non-conducting material, said disk-shaped base element configured to receive and hold the toroidal-shaped magnetic core element of the rotor assembly.

13. The rotor assembly of claim 12 wherein the disk-shaped base element comprises concentric inner and outer annular lips axially protruding from its surface, said inner and outer annular lips forming an annular cavity configured to receive and hold the toroidal-shaped magnetic core element of the rotor assembly.

14. The rotor assembly of claim 13 wherein the disk-shaped base element comprises a plurality of radial grooves passing between and through the concentric inner and outer annular lips and configured to facilitate passage of air therethrough for ventilating the stator assembly during operation of the axial-gap electric machine.

15. An axial-gap electric machine comprising:
at least one stator assembly of claim 1;
a rotatable shaft located in a central passage along said stator assembly; and
at least one rotor assembly comprising: a toroidal-shaped magnetic core element formed from a spiral wound of magnetic ribbon, said toroidal-shaped magnetic core element comprising a plurality of radial grooves extending between inner and outer rings of its spiral wound ribbon; and a spider-shaped electrically conducting structure constituting a secondary winding of said axial-gap electrical machine, said electrically conducting spider structure comprising a plurality of electrically conducting spokes radially extending between concentric inner and outer electrically conducing rings electrically connected to said spokes, each of said electrically conducting spokes configured to be received at least partially in a respective one of the radial grooves of said toroidal-shaped magnetic core element, said at least one rotor assembly concentrically mounted on said rotatable shaft such that an axial-gap is formed between the spider-shaped electrically conducting structure and said at least one stator assembly.

16. A method of constructing a stator assembly for an axial-gap electric machine, the method comprising:
preparing one or more rectangular-shaped toroid structures from wound magnetic ribbon media, and cutting from said rectangular-shaped toroid structure one or more rectangular parallelepiped pieces;
cutting from each of said rectangular parallelepiped pieces one or more prism-shaped magnetic core elements;
placing over each of said prism-shaped magnetic core elements one or more coils, said coils constituting a primary winding of said axial-gap electric machine; and
circumferentially mounting said prism-shaped magnetic core elements within a support structure about and parallel to an axis or rotation of said electric machine such that an apex angle of said prism-shaped magnetic core elements is directed towards said axis of rotation, and planes of symmetry of said prism-shaped magnetic core elements radially extends from said axis of rotation.

17. The method of claim 16 wherein the mounting of the prism-shaped magnetic core elements within the support structure comprises attaching said prism-shaped magnetic core elements between two electrically non-conducting and non-magnetic disk-shaped support elements.

18. The method of claim 16 comprising interconnecting between the coils to form a three-phase coil system configured to provide a determined number magnetic poles to said stator assembly.

19. The method of claim 16 wherein the stator assembly comprises eighteen prism-shaped magnetic core element, and wherein the interconnecting between the coils is configured to form six magnetic poles.

20. A method of constructing a rotor assembly for the axial-gap electrical machine comprising the stator assembly of claim 16, the method comprising:
preparing a toroidal-shaped magnetic core element from a spiral wound of magnetic ribbon media;
forming in said toroidal-shaped magnetic core element a plurality of radial grooves extending between inner and outer rings of its spiral wound ribbon media;
preparing a spider-shaped electrically conducting structure by electrically connecting a plurality of electrically conducting spokes between concentric inner and outer electrically conducing rings, said spider-shaped electrically conducting structure constituting a secondary winding of said axial-gap electrical machine; and
attaching said spider-shaped electrically conducting structure to said toroidal-shaped magnetic core element such that each of the electrically conducting spokes of said spider-shaped electrically conducting structure is received at least partially in a respective one of the radial grooves of said toroidal-shaped magnetic core element.

21. The method of claim 20 wherein the preparing of the spider-shaped electrically conducting structure comprises using electrically conducting plates to implement the spokes.

22. The method of claim 21 wherein the preparing of the spider-shaped electrically conducting structure comprises placing the electrically conducting plates in respective radial grooves of the toroidal-shaped magnetic core such that a portion of each of the electrically conducting plates protrude outwardly from the respective radial groove.

23. The method of claim 20 comprising determining geometrical dimensions of the electrically conducting plates to set a defined efficiency factor of the axial-gap electrical machine.

24. The method of claim 20 comprising preparing a disk-shaped base element made of a nonmagnetic and electrically non-conducting material, and attaching the toroidal-shaped magnetic core element of the rotor assembly to said disk-shaped base element.

25. The method of claim 24 comprising forming an annular cavity in the disk-shaped base element and placing the toroidal-shaped magnetic core element of the rotor in said annular cavity.

26. The method of claim 25 comprising forming a plurality of radial grooves in the disk-shaped base element before placing the toroidal-shaped magnetic core element in the annular cavity, to thereby facilitate passage of air and ventilation of the stator assembly during operation of the axial-gap electric machine.

27. A method of constructing an axial-gap electric machine comprising:
preparing at least one stator assembly according to claim 16;
placing a rotatable shaft in a central passage passing inside said stator assembly;
preparing at least one rotor assembly as follows: preparing a toroidal-shaped magnetic core element from a spiral wound of magnetic ribbon media; forming in said toroidal-shaped magnetic core element a plurality of radial grooves extending between inner and outer rings of its spiral wound ribbon media; preparing a spider-shaped electrically conducting structure by electrically connecting a plurality of electrically conducting spokes between concentric inner and outer electrically conducing rings, said spider-shaped electrically conducting structure constituting a secondary winding of said axial-gap electrical machine; attaching said spider-shaped electrically conducting structure to said toroidal-shaped magnetic core element such that each of the electrically conducting spokes of said spider-shaped electrically conducting structure is received at least partially in a respective one of the radial grooves of said toroidal-shaped magnetic core element; and
mounting said at least one rotor assembly on said rotatable shaft such that an axial-gap is formed between the spider-shaped electrically conducting structure of the rotor and said at least one stator assembly.

28. An axial-gap electric machine comprising:
at least one stator assembly comprising a plurality of prism-shaped magnetic core elements made from a plurality of magnetic ribbon layers extending along its length, and a primary winding comprising a plurality of coils mounted over said prism-shaped magnetic core elements;
a rotating shaft passing through a central channel of said stator assembly; and
at least one rotor assembly connected to said shaft and comprising a toroidal-shaped magnetic core element made of a spiral wound magnetic tape or ribbon, and a secondary winding comprising a set of electrically conductive rods or plates radially extending between concentric inner and outer electrically conductive rings and electrically connected to said electrically conductive rods or plates, said electrically conductive rods or plates are at least partially located within radial grooves formed in said toroidal-shaped magnetic core element.

29. The electric machine of claim 28 wherein the at least one stator assembly is configured to provide eighteen prism-shaped magnetic core elements and form six magnetic poles.

30. The electric machine of claim 28, wherein the electrically conductive rods or plates of the secondary winding of rotor assembly are configured to form a plurality of fan blades configured to direct air flow towards the stator assembly during operation of the electric machine.
